(19) United States
(12) Patent Application Publication
(10) Pub. No.: US 2017/0184135 A1
(43) Pub. Date: Jun. 29, 2017

(54) HYDRAULIC CONNECTION HAVING A FLEXIBLE PORT MOUTH AND METHOD FOR CONNECTING SAME

(71) Applicant: SPX FLOW, Inc., Charlotte, NC (US)

(72) Inventor: Michael T. Landrum, Rockford, IL (US)

(21) Appl. No.: 15/382,151

(22) Filed: Dec. 16, 2016

Related U.S. Application Data
(60) Provisional application No. 62/387,137, filed on Dec. 23, 2015.
(60) Provisional application No. 62/387,138, filed on Dec. 23, 2015.

(51) Int. Cl. F15B 13/02; F16K 31/60; F15B 11/00; F16K 39/06

(52) U.S. Cl. CPC F15B 13/02; F16K 39/06; F16K 31/602; F15B 11/00; F15B 2211/405; F15B 2211/422

(57) ABSTRACT

A hydraulically balanced assembly is provided. The assembly includes: a valve body defining a tapered axial passageway; and a rotor having a tapered outer diameter such that the rotor has a first portion having a wider diameter and a second portion having a smaller diameter, the rotor being dimensioned to fit within the axial passageway of the valve body, the rotor further defining a rotor axial passageway having a first passageway portion and second passageway portion, the rotor further defining a first and second port, where each of the first and second ports provide fluid communication between the tapered outer diameter and the rotor axial passageway, wherein the first and second portions define openings having different cross-sectional areas where the first passageway portion is located in a first portion of the rotor and a second passageway portion is located in the second portion of the rotor and the difference in cross-sectional areas between the first passageway portion and second passageway portion and the amount of taper of the outer diameter of the rotor are related according to the Landrum relation.

### FIELD OF THE INVENTION

This application claims the benefit of two provisional U.S. patent applications entitled Hydraulic Connection Having a Flexible Port Mouth and Method for Connecting Same, having Ser. Nos. 62/387,137 and 62/387,138 and both filed Dec. 23, 2015. The disclosure of these applications is hereby incorporated by reference in its entirety.

The present invention relates generally to a hydraulic valve. More particularly, the present invention relates to a hydraulic valve having a modular construction and flexible attaching port.

### BACKGROUND OF THE INVENTION

Hydraulic systems use valves to have the hydraulic fluid flow to a desired location. Furthermore, it may be desirable to turn on and off the hydraulic flow. As a result, hydraulic valves are desired. It may also be desirable to balance hydraulic forces placed on hydraulic valves.

Accordingly, it is desirable to provide hydraulic valve that has balanced hydraulic forces and is useful in valving hydraulic fluid.

### SUMMARY OF THE INVENTION

The foregoing needs are met, to a great extent, by the present invention, wherein in one aspect an apparatus is provided that in some embodiments a hydraulic valve system or assembly and method is used to valve hydraulic fluid and to balance the forces placed on the hydraulic valve or valve assembly.

In accordance with one embodiment of the present invention, a hydraulically balanced assembly is provided. The assembly includes: a valve body defining a tapered axial passageway; and a rotor having a tapered outer diameter such that the rotor has a first portion having a wider diameter and a second portion having a smaller diameter, the rotor being dimensioned to fit within the axial passageway of the valve body, the rotor further defining a rotor axial passageway having a first passageway portion and second passageway portion, the rotor further defining a first and second port, where each of the first and second ports provide fluid communication between the tapered outer diameter and the rotor axial passageway, wherein the first and second portions define openings having different cross-sectional areas where the first passageway portion is located in a first portion of the rotor and a second passageway portion is located in the second portion of the rotor and the difference in cross-sectional areas between the first passageway portion and second passageway portion and the amount of taper of the outer diameter of the rotor are related according to the Landrum relation.

In accordance with another embodiment of the present invention, a method of hydraulically balancing a valve is provided. The method includes: fitting a tapered rotor into a valve body having a tapered axial passageway; providing a two-part passageway into the rotor the first part having a larger diameter than the second part; and dimensioning an outer tapered surface of the rotor to a difference in diameter between the first and second parts of the passageway according to the Landrum relation.

In accordance with yet another embodiment of the present invention, an attaching mechanism is provided. The attaching mechanism includes: a first body to finding a tapered dovetail slot; a second body having a tapered dovetail; and a spring loaded projection located in the dovetail slot and the projection is configured to move between an extended position where it extends into the dovetail slot and a retracted position where it does riot extend into the dovetail slot, wherein the dovetail and the dovetail slot are both dimensioned and tapered so that the fitting slides into the dovetail slot and then fits snugly into the valve body and can no longer slide further into the dovetail slot and the spring loaded projection is located in the dovetail slot in a position where it can move to the extended position when the fitting is snugly fit into the valve body and the projection can extend into the dovetail slot trapping the fitting into the dovetail slot.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a perspective view of a modular valve in accordance with an embodiment in accordance with the disclosure.

FIG. 2 is an exploded, perspective view of the valve illustrated in FIG. 1.

FIG. 3 is a side, cross-sectional view of the valve shown in FIG. 1.

FIG. 4 is a perspective view of a flow path through a modular port housing in accordance with an embodiment.

FIG. 5 is an exploded, perspective view of a modular port housing and the valve body showing a flow path through the modular port housing and the valve body where the valve body and the modular port housing are not shown in the same scale.

FIG. 6 is a perspective view of the valve body and the manifold showing a flow path through the valve body and manifold where the valve body and the manifold are not shown in the same scale.

FIG. 7 is a perspective view of the manifold and the valve rotor and a flow path through the manifold and a valve rotor where the manifold and valve rotor are not shown in the same scale.

FIG. 8 is a perspective view of the valve body and rotor.

FIG. 9 is a partial side, see-through view of the valve shown in FIG. 1.

FIG. 10 is a partial, disassembled, view of a modular valve in accordance with an embodiment.

FIG. 11 a cross-sectional view of the valve rotor.

FIG. 12 is a side view of the valve rotor.

FIG. 13 partial, cross-sectional view of a portion of the valve rotor shown in FIG. 12.

### DETAILED DESCRIPTION

The invention will now be described with reference to the drawing figures, in which like reference numerals refer to like parts throughout. An embodiment in accordance with the present invention provides a hydraulic valve utilizing tapered dovetail elements for allowing the valve to be assembled and disassembled in a modular fashion. The dovetail elements reduce the need for threaded fasteners. In some aspects, this disclosure describes a valve that utilizes a tapered valve rotor and element that is pressure balanced or pressure biased to reduce a leakage within the valve and to reduce the effort required to turn the handle. In other embodiments, this disclosure is directed to a valve that utilizes a unique metal seal geometry that reduces a leakage when the seal is under hydraulic pressure. Some embodiments also incorporate a tapered press fit manifold having external grooves to reduce internal communication of flow paths and to reduce the size the manifold and machining required on the manifold. This also allows flow paths to cross.

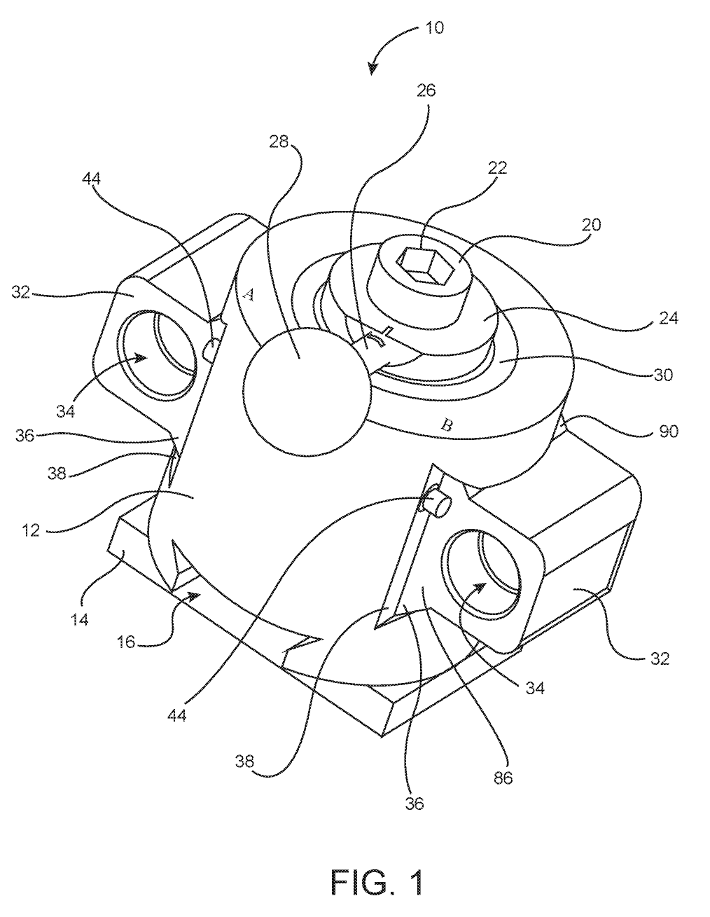

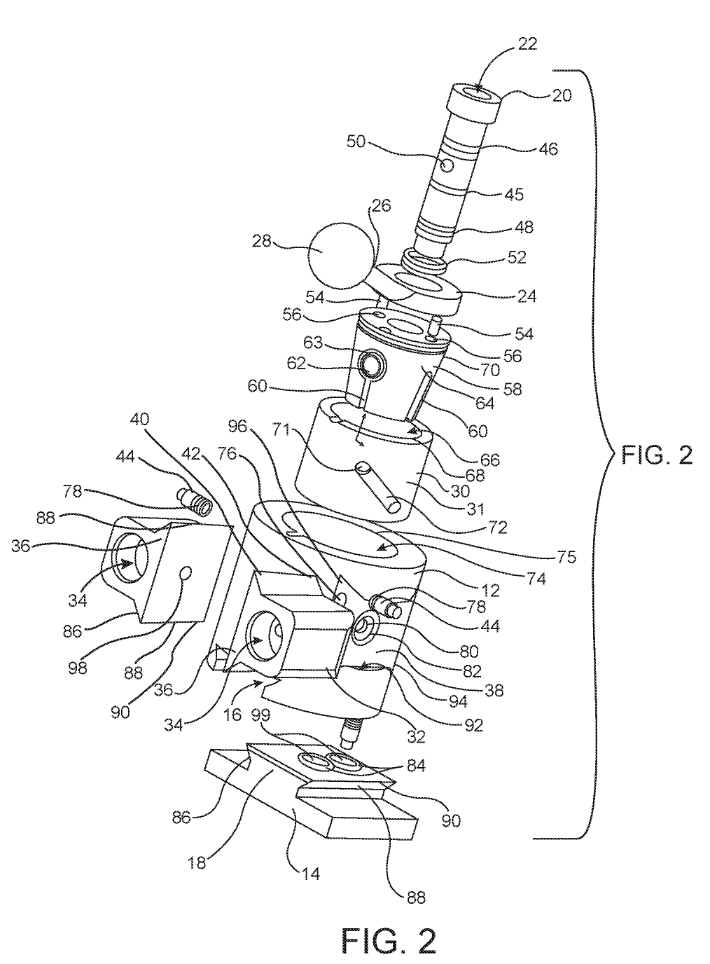

A hydraulic valve 10 is shown in FIG. 1. The hydraulic valve 10 includes a valve body 12. The valve body 12 is mounted to a mounting base 14. In some embodiments, the mounting base 14 may be part of a larger structure to which the hydraulic valve 10 is mounted. The valve body 12 may include a dovetail slot 16 for mounting the hydraulic valve 10 to the mounting base 14. As shown in FIG. 2, the mounting base 14 has a tapered dovetail 18 which may be referred to as the mounting dovetail 18. The mounting dovetail 18 is configured to slide within the mounting dovetail slot 16 located on the valve body 12. In this manner, the hydraulic valve 10 is mounted to the mounting base 14.

Returning to FIG. 1, the hydraulic valve 10 has a center stud 20 that extends through the valve body 12. The center stud 20 may include attaching structure 22 located on the center stud 20. The attaching structure 22 may be in the form of a hex shaped hole as shown. In other embodiments, the attaching structure 22 may be structure configured to allow a tool used for turning. For example, the attaching structure 22 may include other attaching structure such as external flats, a slot for a flat screwdriver to fit in, a Phillips slot, or any other suitable mounting structure 22.

A selector plate 24 may be located adjacent to the center stud 20. The center stud 20 extends through the selector plate 24. A selector rod 26 is mounted to the selector plate 24 and may be equipped with a selector knob 28. A user may grab the selector knob 28 which is attached to the selector rod 26 and rotate the selector rod 26 to thereby cause the selector plate 24 to reach a desired angular position. For example, indicia such as the letters A and B appearing in FIG. 1 may be located on the valve body 12 to assist in allowing a user to move the selector rod 26 to a desired angular position.

A manifold 30 may be located between the valve body 12 and the selector plate 24. Additional discussion and description of the center stud 20 the selector plate 24 and the manifold 30 will occur further below with respect to FIG. 2.

In some embodiments and as shown in FIG. 1, the hydraulic valve 10 may be modularly constructed. Various accessories to the hydraulic valve 10 may be attached or removed from the hydraulic valve 10. For example, a modular valve port housing 32 may be attached to the valve body 12. In some embodiments, two or more, (but only two are shown in the FIGS.) such modular valve port housings 32 may be attached to the valve body 12. Multiple tapered modular port dovetail slots 38 may allow multiple accessories such as modular valve port housings 32 to be attached to the valve 10. One example modular valve port housing 32 will be described below even though more than one is shown in the FIGS. The multiple modular valve port housings 32 have the same or similar parts and therefore only one will be described. One of ordinary skill the art after reviewing this disclosure will understand that the various features described will be relevant to all of the modular valve port housings 32 and corresponding modular port dovetail slots 38.

The modular valve port housing 32 may include a modular valve ports 34 which appear as an opening in the modular valve port housing 32. In some embodiments, as shown in FIG. 1, the modular port valve port 34 may be oriented parallel to the modular valve port dovetail 36. The modular port dovetail 36 may be a tapered dovetail 36 configured to fit in the modular port tapered dovetail slot 38 located in the valve body 12. In some embodiments, the front 40 of the dovetail 36 may be wider than the rear 42 of the dovetail 36 such that as the modular valve port housing 32 and moves through the modular tapered dovetail slot 38, the modular port dovetail 36 will start to have an interference fit with the modular port dovetail slot 38 and at some point will no longer be able to slide in the modular port dovetail slot 38 in the direction of the rear 42 of the dovetail 36.

To secure the modular valve port housing 32 in the modular port tapered dovetail slot 38, a detent pin 44 is located in the modular port tapered dovetail slot 38. The detent pin 44 is spring-loaded and can move between an extended and retracted position. The position shown in FIG. 1 is the extended position. When the detent pin 44 is in the extended position, the detent pin 44 prevents the modular valve port housing 32 from sliding out of the modular port tapered dovetail slot 38 in the direction of the front 40 of the dovetail 36. When it is desired to either attach or remove the modular valve port housing 32 the detent pin 44 can be depressed to overcome the spring bias and be moved out of the way to allow the modular valve port housing 32 to be moved within the modular port tapered dovetail slot 38.

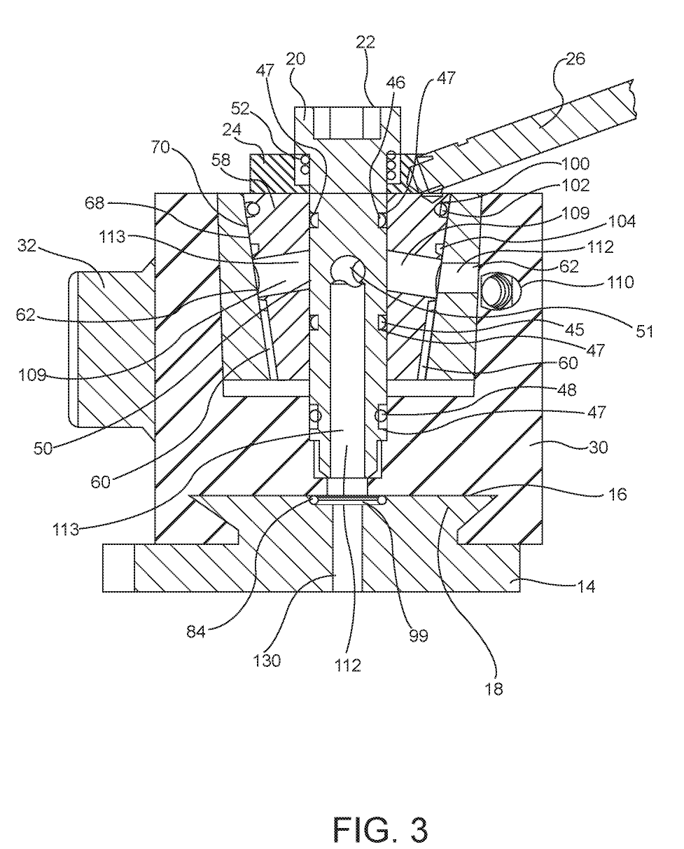

FIG. 2 is an exploded view of the hydraulic valve. The center stud 20 is shown with the attaching structure 22 located on the top of the center stud 20. The center stud 20 also has a first seal 45, a second seal 46 and a third seal seal 48. The seals 45, 46 and 48 may be in the form of O-rings residing in respective grooves 47. A stud port 50 is located in the center stud 20 which can be a through hole. The stud ports 50 and 51 provides fluid access to center bores 111 and 113, through an annulus which will be described additionally below with respect to FIGS. 3, 4 and 5. A biased spring 52 is located around the center stud 20. The selector plate 24 with the selector rod 26 and selector knob 28 are shown. Attaching pins 54 fit within pin holes 56 located in the valve rotor 58. The pins 54 also fit within pin holes (not shown) in the selector plate 24. The selector plate 24 is rotationally locked to the valve rotor 58 via the pins 54 angular movement of the selector rod 26 via the selector knob 28 will cause the valve rotor 58 to rotate to various angular positions.

The valve rotor 58 may be equipped with grooves 60 which provide a fluid pathway along the outer portion of the valve rotor 58. The valve rotor 58 may also include one or more ports 62. The exterior of the valve rotor 58 may have a tapered surface 64. The valve rotor 58 fits within a hole 66 in the manifold 30. The hole 66 may have a tapered inner surface 68 that is configured to correspond to the taper 64 of the valve rotor 58. In some embodiments, when the valve rotor 58 is located in the manifold 30 the valve rotor 58 can be axially moved to a position so that the exterior taper 64 of the valve rotor 58 is fit to the tapered inner surface 68 in such a manner as to form a fluid tight connection. In this manner, hydraulic fluid at pressure located in the groove 60 may travel along the grooves 60 without leaking along the interface between the tapered inner surface 68 and the outer tapered surface 64 of the valve rotor 58. Fluid flowing through the grooves 60 or port 62 may also flow through the port 71 and groove 72 located in the manifold 30.

The manifold 30 fits within the hole 74 is located in the valve body 12. In some instances, the outer surface of the manifold 30 may also be tapered and a corresponding taper may be found in the hole 74 so that the manifold 30 can be pressed into the hole 74 to a location where the connection between the manifold 30 and the body 12 is a fluid tight connection. The body 12 may also define a hole 76 for the detent pin 44. The detent pin 44 may include a spring 78. The spring 78 biases the pin 44 to an outward position. When the detent pin 44 is depressed the spring 30 is compressed and when the detent pin 44 is released the spring 78 moves the detent pin 44 back to extended position.

The body 12 may also define one or more ports 80. The ports 80 may be associated with various accessories such as the modular port housing 32. The port 80 may also have a face seal 82 surrounding the port 80 to provide a fluid tight connection with the port hole 98 in the modular valve port 34. The port hole 98 provides fluid communication between the port 80 in the body 12 and the modular valve port 34 located within the modular valve port housing 32.

The modular valve port housing 32 shows the narrow rear portion 90 the wide front portion 86 and the taper 88 located on the modular valve port dovetail 36. As discussed above, the tapered slot 92 has a narrow rear portion 94 and a wide front portion 96. The narrow rear portion 94 and the wide front portion 96 are dimensioned so that as the modular valve port dovetail 36 tits into the modular port dovetail slot 38 the modular valve port dovetail 36 will slide part way through the slot 38 and then the taper will cause the modular valve port dovetail 36 to interfere with the modular valve port dovetail slot 38. One of ordinary skill in the art after reviewing this disclosure will appreciate that the dimensions of the taper, the modular valve part dovetail 36 and the modular part dovetail slot 38 will be selected so that the modular valve port housing 32 will slide into the modular part port dovetail slot 38 and past the detent pin 44 allowing the detent dent pin 44 to extend outwardly thereby securing the modular valve port housing 32 within the modular valve port slot 38 with the constricting taper at one end and the detent pin 44 at the other end of the modular valve port housing 32.

The mounting base 14 is also shown with the mounting dovetail 18 having a taper 88. The dovetail 18 has a wide front portion 86 and a narrow rear portion 90. The mounting base 14 also contains holes 99 surrounded by face seals 84. The holes 99 are configured to align with corresponding holes (not shown in FIG. 2) in the valve body 12 or features located in the valve body 12. In some embodiments, the taper 88 located on the mounting dovetail 18 corresponds with a taper in the mounting dovetail slot 16. Optionally detent pins 44 may be provided on the dovetail slot 16. The securing of the mounting dovetail 18 into the mounting dovetail slot 16 is done in a similar manner as discussed with respect to the modular valve port dovetail 36 and modular valve port dovetail slot 38 and detent pins 44.

FIG. 3 is a cross-sectional view of the hydraulic valve 10. The center stud 20 with the attaching structure 22 are shown. The biased spring 52 is illustrated in a compressed condition. The seal 102 is located in the seal groove 100 and the seals 45, 46 and 48 are illustrated in their respective grooves 47. The center stud 20 defines an interior center bore 113. The interior center bore 113 is part of an interior fluid passageway 112 which includes the fluid passageways 109 in the rotor 58 and the passageway 130 in the mounting base 14. The passageway 112 may include ports 50 and 62 passageways 109, center bore 113 and passageway 130. The connection between the mounting base 114 and the valve 110 may include a seal 84 around holes 99. The selector plate 24 are shown connected to the selector rod 26. Movement of the selector rod 26 can cause the rotor 58 to rotate in place and thereby misalign the fluid passageway 109 from passageway 112.

The modular valve port housing 32 is shown on the left-hand portion of FIG. 3. However it should be understood that a modular port housing 32 would may be present also on the right-hand side of the drawings FIG. 3 however it has been removed in order to better show the port 110 in the body 12. When the manifold 30 is suitably aligned, fluid can flow from the modular valve port housing 32 through the port 110 in the body 12 through the port 62 and passageway 112 into the valve rotor 58 into the interior bore 113 through hole 99 into the interior passageway 130.

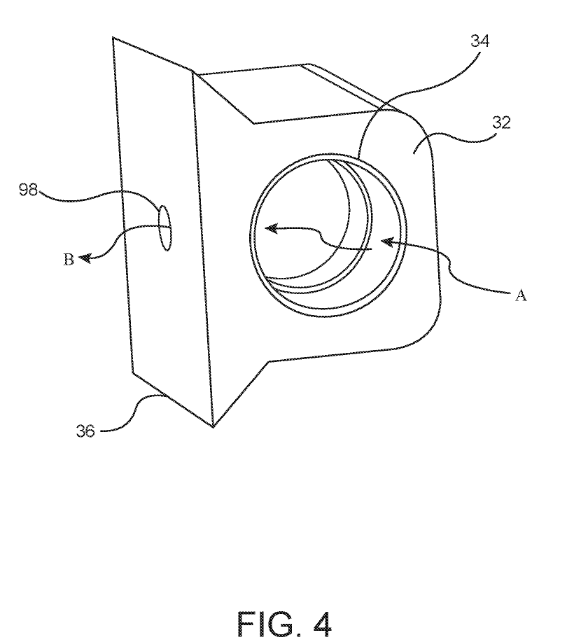

FIGS. 4-9 illustrate how fluid flows through the hydraulic valve 10. As seen in FIG. 4, fluid flows in the direction of arrow A through the modular valve port housing 32 via the modular valve port 34. The fluid flows out of the modular valve port housing 32 in the direction of arrow B through ports hole 98 in the dovetail 36 of the modular valve port housing 32.

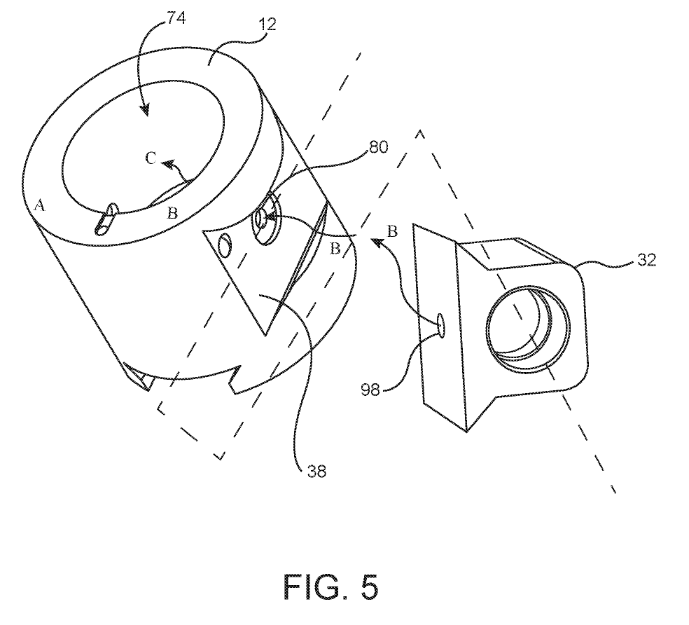

FIG. 5 is an exploded view of the modular valve port housing 32 and the valve body 12. As fluid flows out of the port hole 98 in the modular valve port housing 32 in the direction of arrow B, it flows into the port 80 in the dovetail slot 38 in the valve body 12 into the axial hole 74 in the valve body 12 as illustrated by arrows C as shown in FIG. 5.

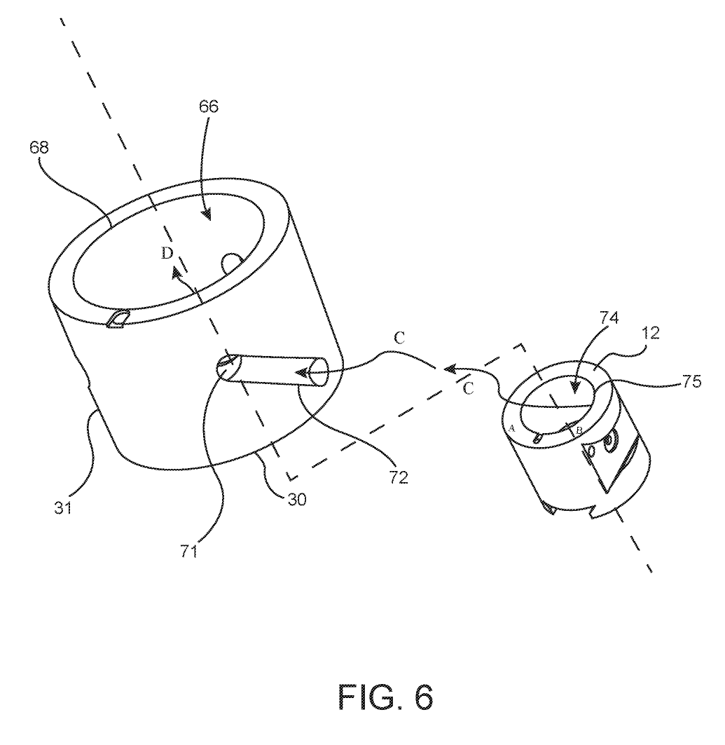

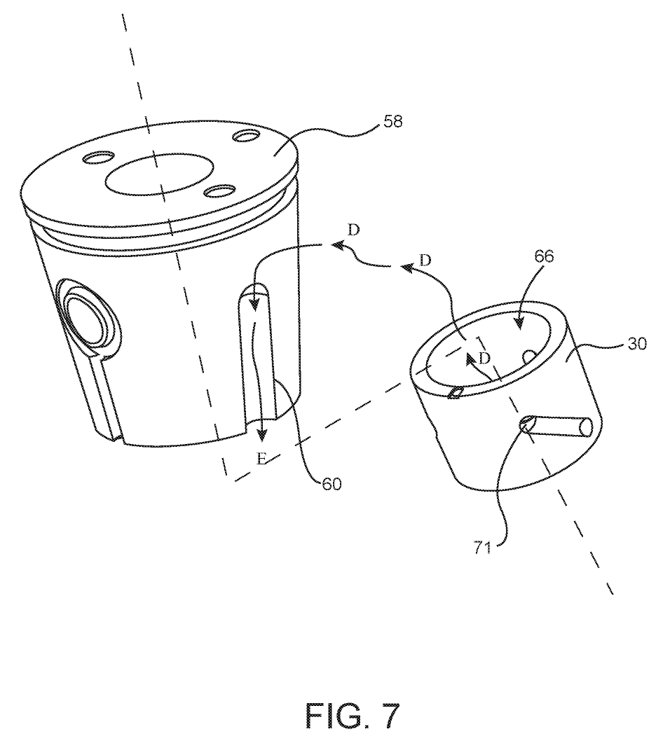

FIG. 6 is an exploded view of the valve body 12 and the manifold 30. The valve body 12 and the manifold 30 are not shown to scale with respect to each other but they do show the flow path along arrows C as the fluid flows through the axial hole 74 out of the valve body 12 and into the groove 72 of the manifold 30 and into the port 71 as shown by arrows C. Once the fluid flows through the port 71 and extends through the manifold 30 as shown by arrow D the fluid flows into the axial hole 66 in the manifold 30. The port 71 will line up to a part of the valve rotor 58 (see FIG. 7) when the valve is shifted to a position because these two lineup. The outer face 31 of the manifold 30 is tapered and fits into a corresponding tapered 75 axial hole 74 and the valve body 12 these two tapered surfaces 31 and 75 may be press fit together to form a seal and therefore is the valve body 12 and the manifold 30 do not rotate with respect to each other.

FIG. 7 is an exploded view showing the valve rotor 58 and the manifold 30. The manifold 30 is not shown in the same scale as the rotor 58 but are shown together to illustrates the flow path as illustrated by arrows D from the manifold 30 to the valve rotor 58. The fluid flows out of the axial hole 66 in the manifold 30 and into the groove 60 in the valve rotor 58. The fluid flows along the groove 60 in the direction of arrow E. The groove 60 may be lined up with the hole or port 71 in the manifold 30 due to the position of the valve rotor 58 as selected by an operator. As a result, depending upon the position of the valve rotor 58 as controlled by an operator the fluid may or may not flow along the flow path indicated by arrows D and E. For example, when the port 71 is not aligned with the groove 60 the fluid will not flow.

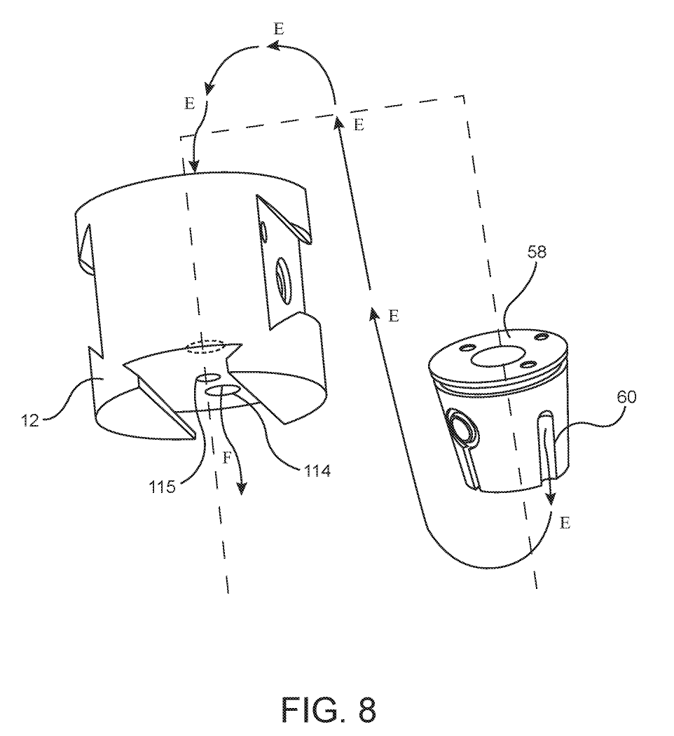

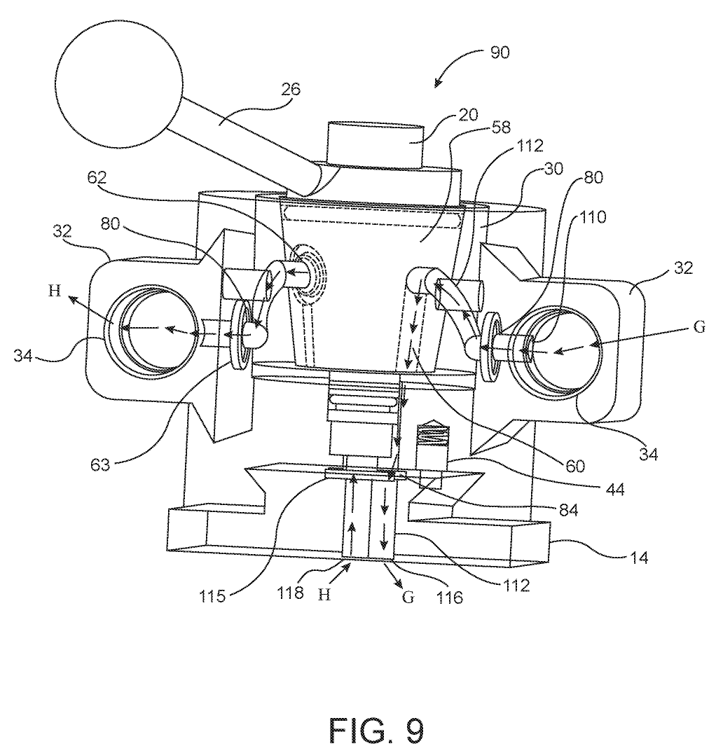

FIG. 8 is an exploded view of the valve rotor 58 and the valve body 12. The valve rotor 58 in the valve body 12 are not shown to scale with respect to each other but are both merely a list shown to illustrate the flow path of fluid from the valve rotor 58 to the valve body 12. As the fluid flows along the groove 60 along the direction of arrows E, the fluid will flow into the valve body 12 and through a bottom port 114 in the valve body 12. The fluid will then flow into the mounting base 14 and out of the base port 114 in the mounting base 14 shown in FIG. 9.

FIG. 9 is an assembled view of the hydraulic valve 10. Arrows G illustrate a flow path through the valve body 12 through the modular valve port 34 and ultimately through the base port 116 in the mounting base 14. Arrows H show fluid flowing up through the base port 118 and into the valve body 12 via bottom body port 115 and ultimately out of the modular valve port 34. While the exploded view of figures for through 7 illustrate the general flow path illustrated by arrows G in FIG. It will be apparent to one of ordinary skill the art after reviewing this disclosure that the general flow path shown in FIG. 9 illustrated by arrows H is very similar (and may the same or a mirror image) to the flow path illustrated by arrows G in FIG. 9. As a result, FIG. 9 will not be explained in full detail as it is merely an assembled view showing flow paths G and H as already explained above. The elements of FIG. 9 have already been explained above and will not be repeated here.

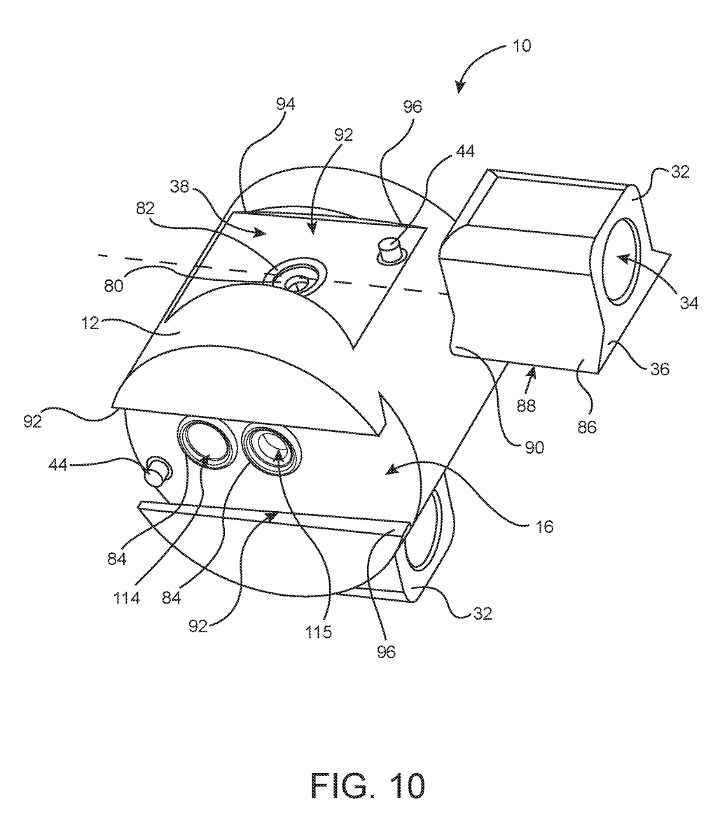

FIG. 10 is a partially disassembled view of the hydraulic valve 10 the modular valve port housing 32 shown to be aligned with but not yet inserted into the modular port dovetail slot 38 located on the valve body 12. The modular valve port 34 can be seen to extend axially into the modular valve port housing 32. The modular port dovetail 36 is seen along with the wide front portion 86 and the narrow rear portion 90. The difference in the dimensions between the wide front portion 86 and the narrow rear portion 90 of the dovetail 36 illustrates the taper 88 in the dovetail 36. The tapered slot 92 in the valve body 12 has a wide front portion 96 and a narrow rear portion 94. The tapered slot 92 is dimensioned to correspond to the dovetail 36 and allow the modular valve housing 32 to move within the tapered slot 92 to a predetermined location. In some embodiments, it is preferred that the port hole 98 (best seen in FIG. 2) in the modular valve port housing 32 aligns with the port 80 in the tapered slot 92. The face seal 82 can be seen surrounding the port 80. A second modular valve port housing 32 is shown to be located and mounted on the valve body 12.

The mounting dovetail slot 16 is shown which also has a wide front portion 96 the narrow rear portion 94 forming, a taper 92. The bottom body ports 114 and 115 are seen. The face seals 84 are also shown.

Both detent pins 44 are shown in the extended position but can be depressed to allow dovetail to move into the various dovetail slots and then moved to an extended position to lock whatever features located in the slot in position.

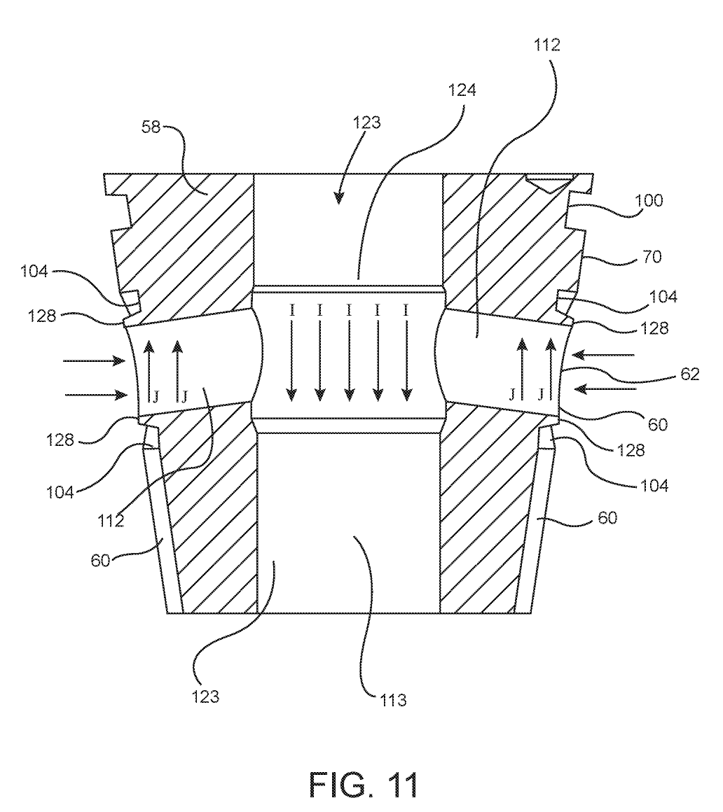

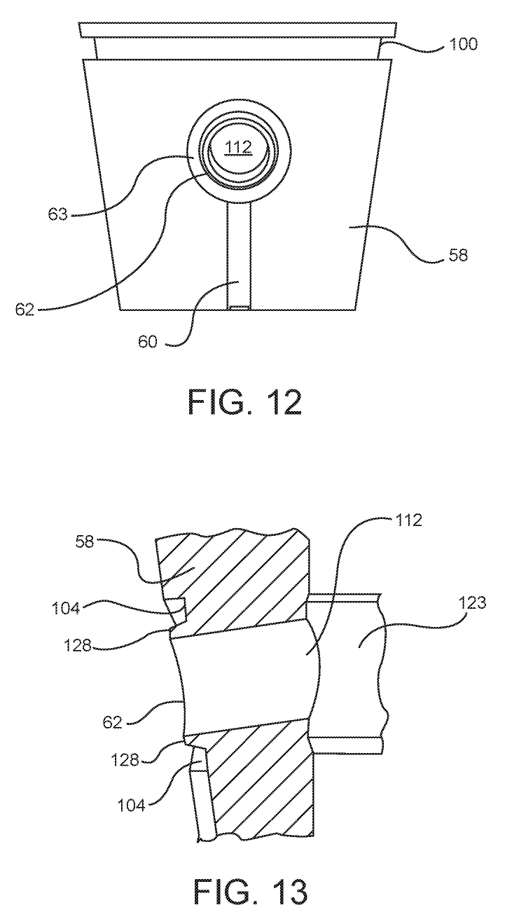

FIG. 11 is a cross-sectional view of the valve rotor 58. FIG. 12 is a side view of the valve rotor 58 and FIG. 13 is a an enlarged partial cross-sectional view of the valve rotor 58. These three figures will be discussed together. The valve rotor 58 is generally conical in shape and includes a seal groove 100 near its top end. The valve rotor 58 includes a interior passage 123 which includes a larger diameter portion 124 and a second more narrow diameter bore 113. Sizing the larger diameter bore 124 and the more narrow diameter bore 113 helps to cause the valve rotor 58 to be axially balanced when the high-pressure hydraulic fluid is flowing through, the valve rotor 58. For example, the tapered outer surface 70 of the valve rotor 58 will tend to urge the valve rotor 58 in an upward direction as shown by arrows J in FIG. 11. To counteract this tendency, the larger diameter passage 124 and more narrow down or passage 113 are sized to create a hydraulically balanced valve rotor 58. Hydraulic fluid flowing from the larger diameter 124 to the smaller diameter 113 passageways will cause a force the direction of arrows I. This sizing of the valve rotor 58 to relate difference in diameter of the larger diameter passage 124 and the more narrow passage 113 with the degree of taper of the outer surface 70 of the valve rotor 58 to cause the value rotor 58 to be neutrally balanced when there is pressured hydraulic fluid flowing the valve rotor 58 is referred to in this document as the Landrum relation.

The ports 62 to provide entry to passageways 112 and into the interior passage 123. The ports 62 are surrounded by a seal groove 104. A port ridge 128 is located between the seal groove 104 and the port 62. The seal groove 128 is content figured to flex outwardly toward the seal groove 104 when hydraulic fluid is flowing through the valve rotor 58.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A hydraulically balanced assembly comprising:
a valve body defining a tapered axial passageway; and
a rotor having a tapered outer diameter such that the rotor has a first portion having a wider diameter and a second portion having a smaller diameter, the rotor being dimensioned to fit within the axial passageway of the valve body, the rotor further defining a rotor axial passageway having a first passageway portion and second passageway portion, the rotor further defining a first and second port, where each of the first and second ports provide fluid communication between the tapered outer diameter and the rotor axial passageway,
wherein the first and second portions define openings having different cross-sectional areas where the first passageway portion is located in a first portion of the rotor and a second passageway portion is located in the second portion of the rotor and the difference in cross-sectional areas between the first passageway portion and second passageway portion and the amount of taper of the outer diameter of the rotor are related according to the Landrum relation.

2. The hydraulically balanced assembly according to claim 1, wherein the first and second ports are located about 180° from each other.

3. The hydraulically balanced assembly according to claim 1, wherein the first and second ports are actually misaligned with each other.

4. The hydraulically balanced assembly according to claim 1, wherein at least one of the of the first and second ports are encompassed by a groove in the outer diameter of the rotor creating a thin member between the port and the groove.

5. The hydraulically balanced assembly according to claim 4, wherein the thin member is configured to flex outward toward the groove when thin member is under hydraulic pressure.

6. The hydraulically balanced assembly according to claim 1, further comprising a groove in the tapered outer diameter of the rotor fluidly connecting to at least one port.

7. The hydraulically balanced assembly according to claim 1, wherein the rotor is configured to rotate within the valve body.

8. The hydraulically balanced assembly according to claim 1, further comprising a tapered dovetail slot in the valve body tapered in such a manner that a first end of the tapered dovetail slot is wider than a second end of the tapered dovetail slot.

9. The hydraulically balanced assembly according to claim 1, further comprising a spring loaded projection located in the dovetail slot.

10. The hydraulically balanced assembly according to claim 9, and the projection is configured to move between an extended position where it extends into the dovetail slot and a retracted position where it does not extend into the dovetail slot.

11. The hydraulically balanced assembly according to claim 1, further comprising a fitting having a tapered dovetail dimensioned so that the fitting it may be attached to the valve body via the dovetail sliding into the dovetail slot.

12. The hydraulically balanced assembly according to claim 11, wherein the dovetail and the dovetail slot are both dimensioned and tapered so that the fitting slides into the dovetail slot and then fits snugly into the valve body and can no longer slide further into the dovetail slot.

13. The hydraulically balanced assembly according to claim 1, further comprising
a spring loaded projection located in the dovetail slot and the projection is configured to move between an extended position where it extends into the dovetail slot and a retracted position where it does not extend into the dovetail slot; and
a fitting having a tapered dovetail dimensioned so that the fitting it may be attached to the valve body via the dovetail sliding into the dovetail slot,
wherein the dovetail and the dovetail slot are both dimensioned and tapered so that the fitting slides into the dovetail slot and then fits snugly into the valve body and can no longer slide further into the dovetail slot and the spring loaded projection is located in the dovetail slot in a position where it can move to the extended position when the fitting is snugly fit into the valve body and the projection can extend into the dovetail slot trapping the fitting into the dovetail slot.

14. A method of hydraulically balancing a valve comprising:
fitting a tapered rotor into a valve body having a tapered axial passageway;
providing a two-part passageway into the rotor the first part having a larger diameter than the second part; and
dimensioning an outer tapered surface of the rotor to a difference in diameter between the first and second parts of the passageway according to the Landrum relation.

15. The method of claim 14, further comprising locating two ports in the tapered rotor to provide fluid communication between the outer tapered surface of the rotor and the two-part passageway.

16. The method of claim 15, further comprising locating the two ports about 180° from each other.

17. The method of claim 16, wherein the two ports are axially misaligned.

18. The method of claim 14 further comprising forming a tapered dovetail slot into the valve body.

19. The method of claim 18 further comprising fitting a spring loaded projection into the dovetail slot.

20. An attaching mechanism, comprising:
a first body to finding a tapered dovetail slot;
a second body having a tapered dovetail; and
a spring loaded projection located in the dovetail slot and the projection is configured to move between an extended position where it extends into the dovetail slot and a retracted position where it does not extend into the dovetail slot,
wherein the dovetail and the dovetail slot are both dimensioned and tapered so that the fitting slides into the dovetail slot and then fits snugly into the valve body and can no longer slide further into the dovetail slot and the spring loaded projection is located in the dovetail slot in a position where it can move to the extended position when the fitting is snugly fit into the valve body and the projection can extend into the dovetail slot trapping the fitting into the dovetail slot.
